(19) United States
(12) Patent Application Publication
(10) Pub. No.: US 2024/0118868 A1
(43) Pub. Date: Apr. 11, 2024

(54) MULTIPLIER BLOCK FOR BLOCK FLOATING POINT AND FLOATING POINT VALUES

(71) Applicant: Xilinx, Inc., San Jose, CA (US)

(72) Inventors: Philip Bryn James-Roxby, Longmont, CO (US); Eric F Dellinger, Longmont, CO (US); Nicholas James Fraser, Dublin (IE)

(73) Assignee: Xilinx, Inc., San Jose, CA (US)

(21) Appl. No.: 17/960,693

(22) Filed: Oct. 5, 2022

(51) Int. Cl. G06F 7/487; G06F 7/485; G06F 7/544

(52) U.S. Cl. CPC G06F 7/4876; G06F 7/485; G06F 7/5443

(57) ABSTRACT

A mode control circuit operates a circuit arrangement in either a first mode to multiply floating point operands or a second mode to compute a dot product of two vectors of block floating point values. A block of multiplier circuits generates products from first pairs of p-terms. Each p-term is a portion of a significand of one of the floating point operands when operating in the first mode, or a significand of one of the block floating point values when operating in the second mode. An adder tree that is coupled to the block of multiplier circuits sums the products into a final sum. A floating point conversion circuit is configured to generate a floating point value from the final sum and the floating point operands in response to operating in the first mode, and generate a block floating point value from the final sum in response to operating in the second mode.

### TECHNICAL FIELD

The disclosure generally relates to circuits for multiplication of vectors of block floating point values and multiplication of floating point values.

### BACKGROUND

Floating point representations of numbers generally provide a greater range and more precision than fixed point representations, and arithmetic processors are often specifically configured for processing floating point or fixed point numbers. Speed and efficient hardware implementations make fixed point arithmetic processing popular in many applications, such as signal processing and artificial intelligence.

Block floating point (BFP) methods have been implemented in attempts to provide the benefits of floating point arithmetic on fixed point processors. A block of floating point values can be pre-processed to determine the value of a shared exponent, and a fixed point processor can operate on the significands and exponent. In order to reduce hardware requirements in some applications where high precision is unnecessary, a BFP hardware implementation can use a smaller number of significand bits, for example, 8 bits.

Some hardware platforms are designed to host applications having a wide range of processing requirements, rather than being targeted to a limited type of application. For example, the adaptive system-on-chip (SoC) platforms available from Advanced Micro Devices, Inc. can host applications for digital signal processing, control systems, communications, and artificial intelligence, to name just a few. A platform capable of hosting a variety of applications having a range of arithmetic requirements can require a significant amount of hardware. Some platforms may have a hardware section for performing high precision floating point arithmetic and another hardware section for performing low precision-high performance integer arithmetic.

### SUMMARY

A disclosed circuit arrangement includes a mode control circuit configured to operate the circuit arrangement in either a first mode to multiply a first floating point operand by a second floating point operand or a second mode to compute a dot product of first and second vectors of block floating point values. The circuit arrangement includes a first block of multiplier circuits configured to generate products from first pairs of p-terms. Each p-term is a portion of a significand of either the first or second floating point operand when operating in the first mode, and each p-term is a significand of one of the block floating point values when operating in the second mode. The circuit arrangement includes a first adder tree coupled to the first block of multiplier circuits and configured to sum the products into a first final sum. The circuit arrangement includes a first floating point conversion circuit coupled to the first adder tree and configured to generate a floating point value from output of the first adder tree and the first and second floating point operands in response to operating in the first mode, and generate a block floating point value from output of the first adder tree in response to operating in the second mode.

Another circuit arrangement includes a mode control circuit configured to operate the circuit arrangement in either a first mode to multiply pairs of first and second floating point operands or a second mode to compute dot products of pairs of first and second vectors of block floating point values. The circuit arrangement includes a plurality of blocks of multiplier circuits. Each block of multiplier circuits is configured to generate products from first pairs of p-terms. Each p-term is a portion a significand of either the first or second floating point operand when operating in the first mode, and each p-term is a significand of one of the block floating point values when operating in the second mode. The circuit arrangement includes a plurality of adder trees coupled to the blocks of multiplier circuits, respectively, wherein each adder tree configured to sum the products of the respectively coupled block of multiplier circuits into a final sum. The circuit arrangement includes a plurality of floating point conversion circuits coupled to the adder trees, respectively, wherein each floating point conversion circuits is configured to generate a floating point value from output of the respectively coupled adder tree and the first and second floating point operands in response to operating in the first mode, and generate a block floating point value from output of the respectively coupled adder tree in response to operating in the second mode.

Another circuit arrangement includes a mode control circuit configured to operate the circuit arrangement in a first mode or a second mode to multiply pairs of first and second floating point operands, or a third mode to compute dot products of pairs of first and second vectors of block floating point values. The circuit arrangement includes a plurality of first-type blocks coupled to the mode control circuit and a plurality of second-type blocks coupled to the mode control circuit. Each second-type block is paired with and coupled to one of the first-type blocks. Each first-type block and each second-type block includes a block of multiplier circuits, respectively. The multiplier circuits of each block are configured to generate products from pairs of p-terms, the p-terms input to the multiplier circuits of each first-type block and second type block are significands of the block floating point values of one of the pairs of first and second vectors when operating in the third mode. The p-terms input to the multiplier circuits of each paired first-type block and second-type block are portions of the significands of two pairs of first and second floating point operands while operating in the first mode, and the p-terms input to the multiplier circuits of each paired first-type and second-type blocks are portions of the significands of one pair of first and second floating point operands while operating in the second mode. Each first-type block and each second-type block includes a respective adder tree coupled to the block of multiplier circuits, and each adder tree is configured to sum the products of the coupled block of multiplier circuits into a final sum. Each second-type block is configured to sum the final sum of the paired first-type block with the final sum of the second-type block into a second precision sum in response to operating in the second mode. Each first-type block and each second-type block includes a floating point conversion circuit coupled to the respective adder tree. The floating point conversion circuit of each first and second type block is configured to generate a floating point value at a first level of precision from output of the respective adder tree and the first and second floating point operands, in response to operating in the first mode, and generate a block floating point value from output of the respective adder tree in response to operating in the third mode. The floating point conversion circuit of the second-type block is configured to generate a floating point value at a second level of precision from the second precision sum and the first and second floating point operands, in response to operating in the second mode.

Other features will be recognized from consideration of the Detailed Description and Claims, which follow.

### BRIEF DESCRIPTION OF THE DRAWINGS

Various aspects and features of the circuits and methods will become apparent upon review of the following detailed description and upon reference to the drawings in which:

FIG. 1 shows an exemplary circuit arrangement that can be controlled to compute either dot products of vectors of BFP16 values or products of FP32 or FP64 values;

FIG. 2 shows an exemplary circuit arrangement that implements the multiplier block and adder tree of an S-block in the circuit arrangement of FIG. 1;

FIG. 3 shows an exemplary circuit 300 that implements the multiplier block and adder tree of a D-block of the arrangement of FIG. 1;

FIG. 4 shows a first part of a table that illustrates multiplication of two pairs single precision operands by an S-block and a D-block operating in floating point mode;

FIG. 5 shows a second part of the table that illustrates multiplication of two pairs single precision operands by an S-block and a D-block operating in floating point mode;

FIG. 6 shows a first part of a table that illustrates multiplication of two double precision values by an S-block and a D-block operating in double precision floating point mode;

FIG. 7 shows a second part of the table that illustrates multiplication of two double precision values by an S-block and a D-block operating in double precision floating point mode;

FIG. 8 shows an exemplary circuit that implements a conversion-to-floating-point circuit of an S-block;

FIG. 9 shows an exemplary circuit that implements a conversion-to-floating-point circuit of a D-block; and

FIG. 10 is a block diagram depicting a System-on-Chip (SoC) that can host the multiplication circuitry according to an example.

### DETAILED DESCRIPTION

In the following description, numerous specific details are set forth to describe specific examples presented herein. It should be apparent, however, to one skilled in the art, that one or more other examples and/or variations of these examples may be practiced without all the specific details given below. In other instances, well known features have not been described in detail so as not to obscure the description of the examples herein. For ease of illustration, the same reference numerals may be used in different diagrams to refer to the same elements or additional instances of the same element.

The disclosed circuitry and methods enable use of the same data path for performing either lower precision block floating point calculations or higher precision floating point multiplication. The exemplary circuits described herein can be operated in a first mode for computing a dot product of vectors of block floating point values (e.g., a shared exponent, 1-bit signs, and 7-bit significands), or operated in a second mode for computing a product of two floating point values. In block floating point mode, the circuitry can calculate dot products of vectors or multiply-and-accumulate scalars. In floating point mode, the significands of two high precision floating point values are decomposed into elements for multiplication, accumulation, and conversion back to a floating point product. The floating point mode can include a single precision mode and a double precision mode.

Though the disclosed exemplary circuits are directed to computations on 16-bit block floating point (“BFP16”) values, 32-bit floating point (“FP32”) values, and 64-bit floating point (“FP64”) values, those skilled in the art will recognize that the circuits and methods can be expanded and/or adapted to accommodate computing dot products of vectors for block floating point values of lesser or greater precision and computing products of two floating point values of lesser or greater precision than shown by the examples.

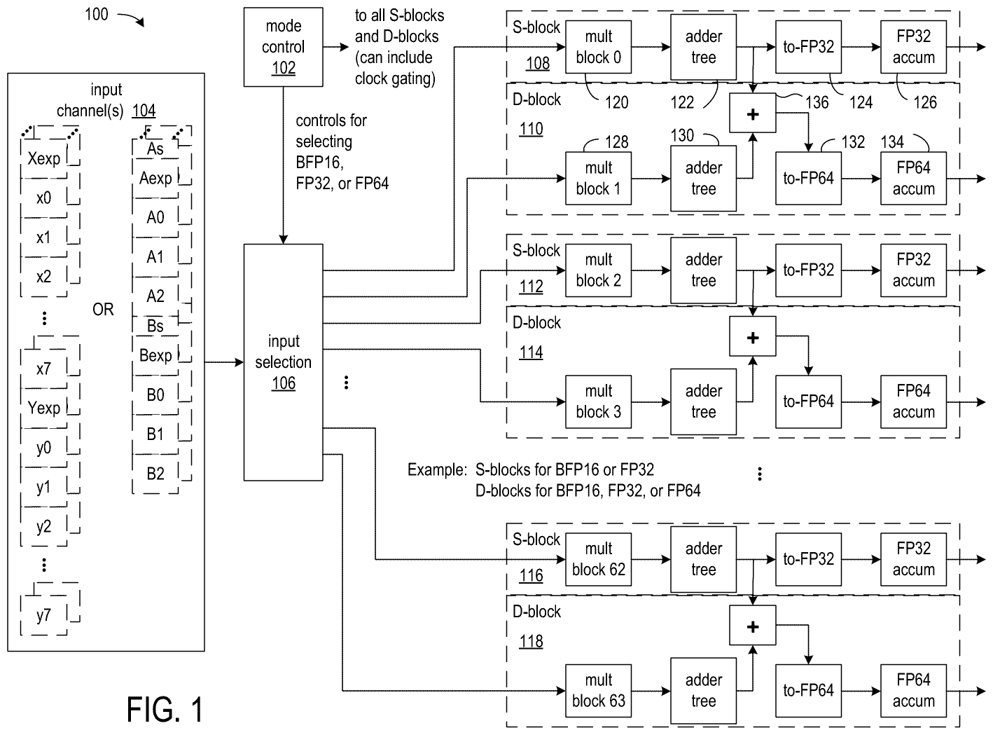

FIG. 1 shows an exemplary circuit arrangement 100 that can be controlled to compute either dot products of vectors of BFP16 values or products of FP32 or FP64 values. The circuit arrangement includes a mode control circuit 102 that controls the circuit arrangement to operate in either a block floating point mode or in a floating point mode. The floating point mode can control different levels of floating point precision, such as single precision, double precision, quad-precision, etc. The exemplary circuits illustrate BFP16, FP32, and FP64 modes. Inputs (not shown) to the mode control circuit for selection of the mode can be signals from a host computer system or states of configuration memory cells, for example.

The input channel(s) 104 can carry the block floating point vectors and floating point operands to the circuit arrangement for processing. The input channel(s) can be a memory mapped or streaming data bus, for example. While operating in in a block floating point mode, BFP vector pairs can be selected from the input channel, and while operating in floating point mode pairs of floating point operands can be selected from the input channel. The input channel is shown with both a pair of exemplary BFP vectors and a pair of floating point operands, though the different types may not be present in the channel simultaneously, depending on the implementation of the input channel(s). The input selection circuit 106 selects the signals of the operands from the input channel according to the mode.

The input selection circuit 106 selects BFP values of pairs of vectors from the input channel 104 when operating in BFP mode. One vector of each pair is denoted “x” and the other vector denoted “y.” The BFP values of vector x are denoted “x0” through “x7”. The exponent of vector x is labeled “Xexp,” and the exponent of vector y is labeled “Yexp.” The significands of the BFP16 values of the vector are normalized so that all the exponent is the same for all elements of the vector.

The input selection circuit 106 selects pairs of floating point operands from the input channel 104 when operating in floating point mode. One operand of each pair is denoted “A” and the other operand is denoted “B.” Portions of the significand of A are denoted “A0,” “A1,” and “A2,” portions of the significand of B are denoted “B0,” “B1,” and “B2.” Operand A has a sign bit labeled “As” and exponent bits labeled “Aexp.” Similarly, Operand B has a sign bit labeled “Bs” and exponent bits labeled “Bexp.” In an FP32 value, for example, bits of A can be denoted A[31:0], where A[0:7] is A2 (the least significant bits of the significand), A[8:15] is A1, and A[16:22] is A0 (the most significant bits of the significand). A0 has an implied leading one bit, and a corresponding explicit 1 bit is input to a multiplier circuit in floating point mode. A[23:30] is Aexp, and A[31] is As. The bit pattern of B is the same as the bit pattern of A.

The exemplary circuit arrangement 100 includes 64 computation blocks. Alternative implementations can be more or fewer computation blocks depending on application requirements. Each computation block is either an “S-block” or a “D-block.” Each S-block and each D-block can compute a dot product of BFP vectors when operating in BFP mode (e.g., each of two vectors having 8 BFP16 values) or a product of single precision (e.g., FP32) operands when operating in floating point mode. Each S-block is paired with a D-block, and together the pair of computation blocks can compute a product of double precision (e.g., FP64) operands. Dashed-line blocks 108, 110, 112, 114, 116, and 118 show the S-blocks and D-blocks. The 64 computation blocks can compute in parallel, dot products of 64 pairs of BFP16 vectors, products of 64 pairs of FP32 operands, or products of 32 pairs of FP64 operands, as controlled by the mode control circuit.

A combined data path for computing the dot product of block floating point vectors or the product of higher precision floating point values can be optimized for speed or hardware resources. To optimize for speed, the circuitry can include the number of multiplier circuits needed to compute all products in parallel. To optimize for hardware resources, multipliers can be shared and different products computed on different cycles. If higher precision is not often needed, a configuration having some sharing of multipliers may be preferred. The illustrated hybrid approach combines the output sums of an adjacent S-block and D-block in double precision floating point mode. The product of two double precision floating point values is computed in two cycles, whereas the product of a single precision floating point value is computed in one cycle

Each of the S-blocks and D-blocks includes a block of multiplier circuits (“mult block), an adder tree, a floating point conversion circuit (“to-FP32” or “to-FP64”), and a floating point accumulator (“FP32 accum” or “FP64 accum”). For example, S-block 108 includes multiplier block 120, adder tree 122, floating pointer conversion circuit 124, and floating point accumulator 126. D-block 110 includes multiplier block 128, adder tree 130, floating pointer conversion circuit 132, and floating point accumulator 134.

Each D-block includes an additional adder circuit that combines the output from the adder tree of the paired S-block with the output of its adder tree. For example, D-block 110 includes adder circuit 136. The adder circuit 136 is operable in double precision floating point mode. In alternative implementations, the floating point mode could be limited to single precision, and all computation blocks could be S-blocks.

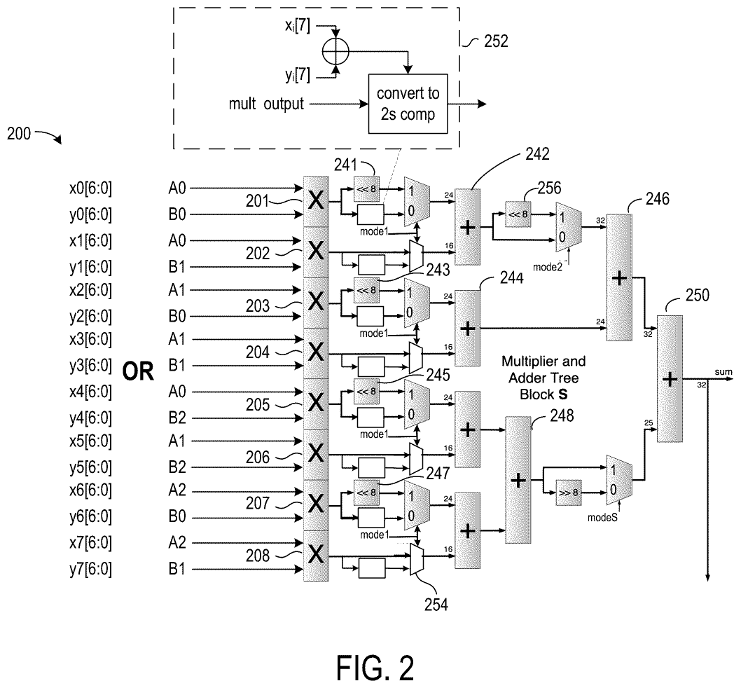

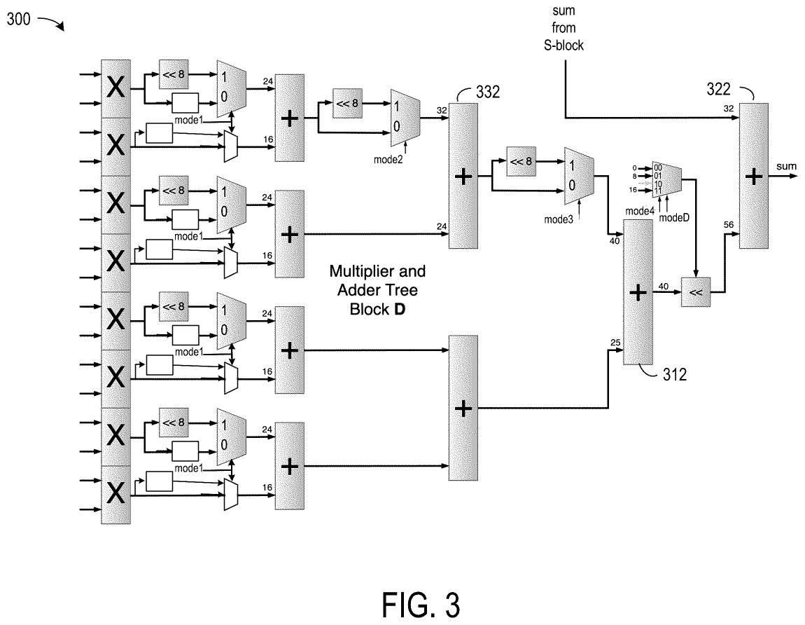

Each block of multiplier circuits includes multiple multiplier circuits. For example, each multiplier block can include 8, 8-bit multiplier circuits (FIGS. 2 and 3). Alternative implementations can have more or fewer multiplier circuits of greater or lesser bit widths. Each block of multiplier circuits is configured to generate products from pairs of “p-terms.” Each p-term is a portion of a significand of either the first or second operand when operating in floating point mode, and when operating in block floating point mode each p-term is a full significand of one of the block floating point values.

Each adder tree sums the outputs from the coupled multiplier block. While operating in floating point mode, each adder tree is responsive to the mode control circuit 102 for aligning products from the multiplier circuits of the multiplier block. While operating in block floating point mode, each adder tree is responsive to the mode control circuit to bypass the aligning of products. The products of p-terms of floating point values are aligned for summing, because the p-terms of floating point significand portions have different relative exponent offsets. Alignment of products of BFP values for summing can be bypassed, because the exponents of the products of the block floating point values are the same.

The conversion to floating point circuit in each S-block (to-FP32) and in each D-block (to-FP64) converts the final sum produced by the adder tree into a floating point value. In each D-block, the conversion to floating point circuit generates a double precision floating point value in response to operating in double precision floating point mode. In response to operating in single precision floating point mode, the conversion to floating point circuit in each D-block generates a single precision floating point value.

Each S-block and each D-block can optionally include a floating point accumulator (“FP32 accum” and “FP64 accum”, respectively). For example, S-block 108 includes floating point accumulator 126, and D-block 110 includes floating point accumulator 134. Each floating point accumulator accumulates a sum from multiple floating point values produced by the coupled conversion to floating point circuit. In single precision floating point mode, the FP64 accumulator produces an FP32 value, and in double precision mode the FP64 accumulator produces an FP64 value.

The input selection circuit 106 selects p-terms, exponents, and sign bits from the input channel for input to the computation blocks based on the mode. In block floating point mode, the input selection circuit selects the significands of block floating point values x0-x7 and y0-y7 and the associated exponents for input to one of the S-blocks or D-blocks. The significands and sign bits are routed to the multiplication block, and the exponent is routed to the floating point conversion circuit. In single precision floating point mode, the input selection circuit selects the portions of the significands of A and B (A0-A2 and B0-B2), the associated exponents, and the associated sign bits for input to one of the S-blocks or D-blocks. In double precision floating point mode, the input selection circuit selects the portions of the significands (not shown) for input as p-terms to a paired S-block and D-block. The associated exponents and the associated sign bits are selected for input to the D-block of the pair.

The mode control circuit 102 provides control signals to the input selection circuitry and control signals to the S-blocks and D-blocks to signal block floating point mode, single precision floating point mode, or double precision floating point mode. In addition, the mode control circuit can gate the clock signals to the multiplier circuits in each multiplier block for saving power in processing lower precision floating point operands. For example, a tensor float 32 (“TF32”) value has a 10-bit significand as compared to the 23-bit significand of an FP32 value. The product of two TF32 operands can be computed using three multiplier circuits of a multiplier block (p-terms of 4 bits), and the clock signals to the 5 unneeded multiplier circuits can be switched off. The mode control circuit can gate clock signals for enabling and disabling selected ones of the multiplier circuits according to a level of precision of operands when operating in the floating point mode.

FIG. 2 shows an exemplary circuit arrangement 200 that implements the multiplier block and adder tree of an S-block in the circuit arrangement of FIG. 1. Depending on the mode, the input p-terms to the multiplier circuits are either the full significands of BFP values of two vectors (e.g., bits 0-6 of each of the block floating point values) or portions of the significands of floating point values A and B (A p-terms A0-A3 and B p-terms B0-B3). The 8 multiplier circuits input 8-bit unsigned integers, and each multiplier circuit produces a 16-bit product. The multiplier circuits are referenced as 201, 202, 203, 204, 205, 206, 207, and 208.

The pairs of p-terms of A and B input to the multiplier circuits include all possible combinations of p-terms A0-A3 with p-terms B0-B3, with the exception of A3 and B3. The product A3*B3 need not be computed, because the product would have an exponent 32 bits less than the final exponent and thereby not contribute to the final value. A0 and B0 from the input channel have implied 1-bits as the MSBs, and the implied 1-bits are made explicit 1-bits as the MSBs of the p-terms A0 and B0 input to the multiplier circuits.

The product of A0*B0 has a notable property. Both A0 and B0 have a leading 1 bit, and the product represents the greatest possible exponent. Thus, the final sum will have a leading 1 in either the MSB or MSB-1 (bits 31 or 30 of a 32-bit unsigned integer [31:0]). The greatest possible product of A0 and B0 is 0xFF*0xFF=0xFE01, and the least possible product is 0x80*0x80=0x4000. If the MSB is 1, the final unbiased exponent will be the sum of exponents of A and B. Otherwise, the final unbiased exponent is one less than the sum of the exponents of A and B. As a result of the consecutive zeros in the greatest possible exponent, 0xFE01, there can be no ripple carry that will overflow a 32-bit unsigned integer, which simplifies normalization.

In floating point mode, the products from the multiplier circuits have different relative magnitudes according to the positions of the p-terms in the significands of A and B. In floating point mode, the mode control circuit controls the adder tree to align the products and sums of the adders for proper summing. For example, the product of A0*B0 will have an effective of exponent of Aexp+Bexp. For the product of A0*B1, the A0 term has an effective exponent of Aexp, and the B1 term has an effective exponent of Bexp−8. Thus, the product of A0*B1 will have an effective exponent of Aexp+Bexp−8. The “exponent offset” of A0*B1 is −8 as the effective exponent of A0*B1 is 8 less than the exponent of the product of the most significant p-terms, A0*B0.

Because the effective exponent of A0*B1 is 8 less than the effective exponent of A0*B0, the product A0*B0 is shifted left by shift circuit 241 (such as in a shift register) by 8 bits for alignment before summing. The product of A0*B0 is 16 bits and the left shift by 8 bits brings the total to 24 bits, which is summed with the 16-bit product of A0*B1. The shift circuits 243, 245, and 247 similarly shift the products of A1*B0, A0*B2, and A2*B0 for proper alignment before summing. The output of adder 242 is shifted left by 8 bits by shift circuit 256 for alignment with the output of adder 244 and summing by adder 246.

The control signals mode1, mode2, and modeS control whether or not the adder tree aligns products and sums for adding. In single precision and double precision floating point modes, the adder tree aligns products and sums for adding, and in block floating point mode no alignment is needed and alignment is bypassed. The adder tree produces a 32-bit final sum. The mode2 signal enables a left shift by 8 of the output from adder 242 for input second-level adder level 246. This shift is used for cases in which the exponent offset between the addends for adder 246 is 8, though the exponent offset is usually zero. The modeS signal (single precision floating point mode) controls selection of truncated output from second-level adder 248. In single point precision mode, the 8 LSBs from adder 248 do not contribute to the output, and the truncation avoids adder 250 being a 40-bit adder.

The first-level multiplexers (i.e., multiplexers aligned in a column with multiplexer 254) select the inputs to the first-level adders according to the state of the mode1 signal. In block floating point mode, the mode1 signal is logic 0, and the values generated by the twos-complement conversion circuits (e.g., circuit 252) are selected for input to the first-level adders. In floating point mode, the mode1 signal is logic 1, and the aligned products are selected for input to the first-level adder circuits.

In block floating point mode, the products are converted to twos-complement format before input to the first level adders, so that the conversion to floating point circuit can produce the proper sign bit. Block 252 illustrates a circuit for converting a product from a multiplier to twos-complement format. The sign bits of the block floating point values (xᵢ[7] and yᵢ[7]) are XOR'd, and the convert-to-twos-complement circuit uses the output of the XOR circuit and output from the multiplier to generate a twos complement value. Alternatively, the block floating point significands and sign bits can be can converted to twos-complement format prior to input to the multipliers.

FIG. 3 shows an exemplary circuit 300 that implements the multiplier block and adder tree of a D-block of the arrangement of FIG. 1. The product of two double precision floating point values is computed in two cycles, whereas the product of a single precision floating point value is computed in one cycle. In double precision floating point mode, the lowest magnitude products can be computed in the first of the two cycles, and those products would have exponent offsets 32 less than the exponent offsets in the S-block. The circuit arrangement of the D-block is similar to that of the S-block, with the exception of the final adder 312 being 40 bits wide to support double precision floating point mode. The D-block includes an additional adder 322 that adds the sum from the paired S-block and the sum from adder 312.

The sum from adder 332 in the D-block is aligned in the second cycle as controlled by the mode3 control signal. Also in double precision floating point mode, the sum from adder 312 is left shifted of 8 on the first cycle and left shifted by 16 bits on the second cycle as controlled by the mode 4 and modeD control signals.

The sum of the first cycle is normalized and rounded (“modeD” is logic 1) into the FP64 accumulator, and in the second cycle the sum of the second cycle is normalized and rounded and accumulated with the sum of the first cycle by the FP64 accumulator.

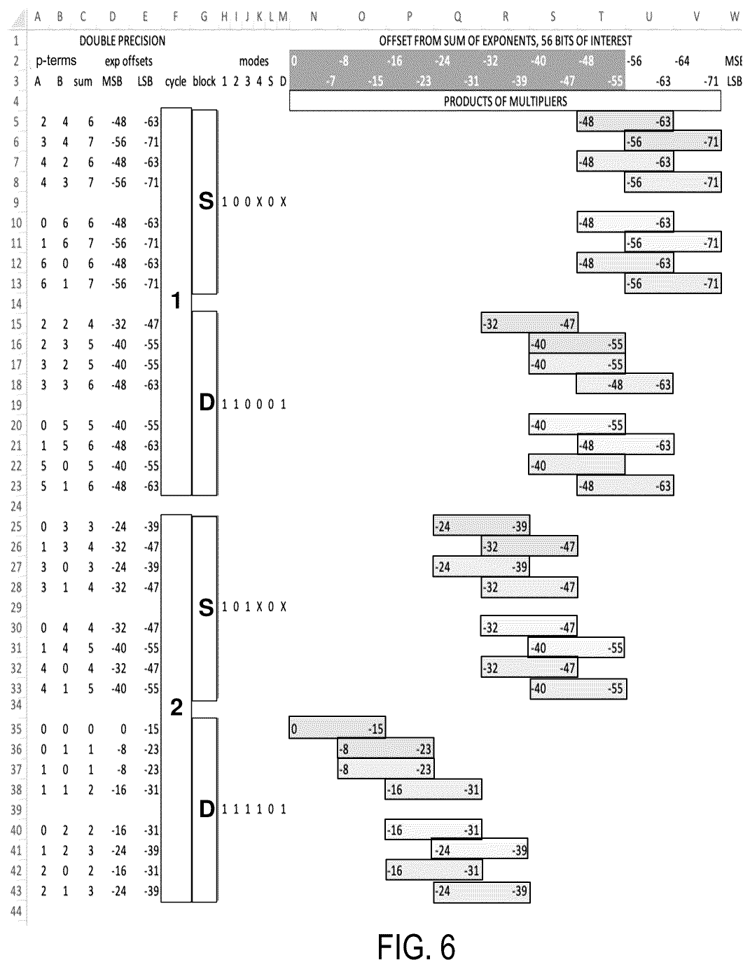

An example of the selection and provision of p-terms to an S-block and a D-block over two cycles is shown in the table of FIG. 6. In general, the number of p-terms is the number of significand bits divided by 8 and rounded up to the nearest integer. Double precision values have 53 significand bits, therefore seven terms. The number of products is the square of the number of p-terms. However, not all of the products contribute to the final result. Therefore, computing those products is unnecessary. For many applications, only 34 of 49 products are potentially relevant, and performing only 32 multiplications may be sufficient for a desired level of accuracy.

In double precision mode, the low magnitude products and sums are computed first so that the products contribute to the final result. If the calculation was an accumulation of multiple products (of different double precision pairs) one embodiment would be to perform the first half of the computation for each of those pairs (doing low magnitude) before making a second pass through the data with high magnitudes.

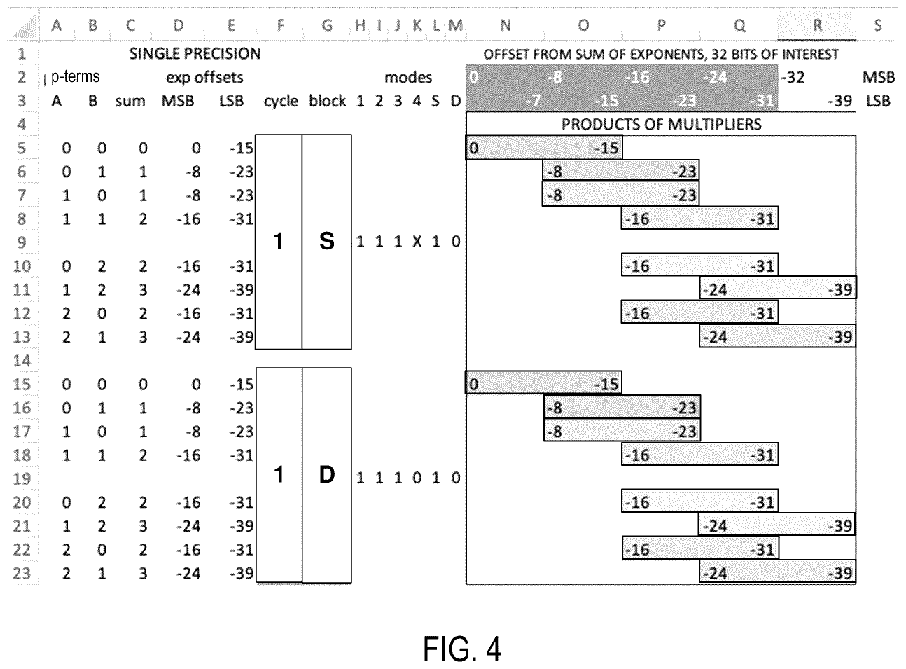

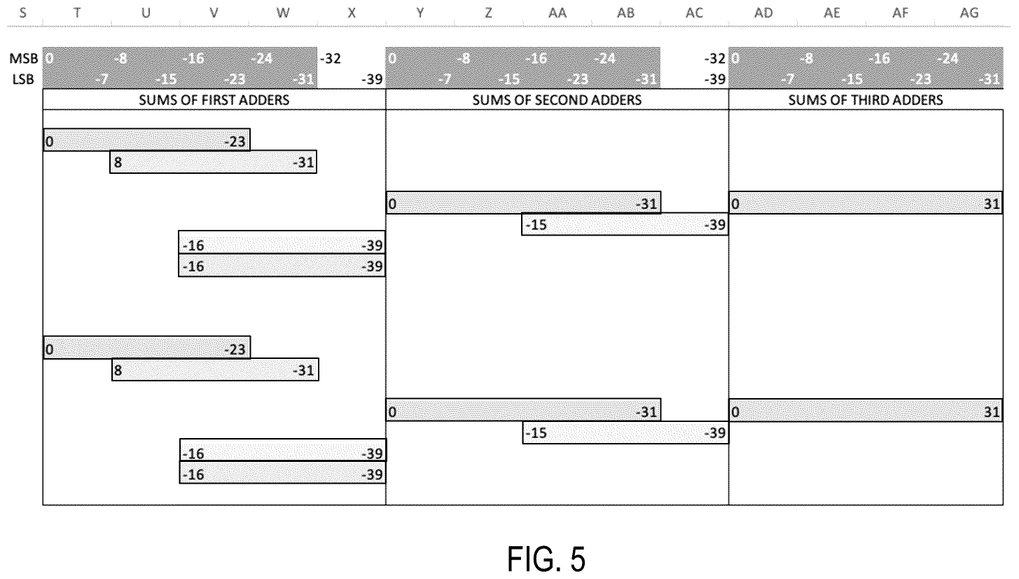

FIG. 4 shows a first part and FIG. 5 shows a second part of a table that illustrates multiplication of two pairs single precision operands by an S-block and a D-block operating in floating point mode. FIG. 4 shows the input pairs of p-terms, states of mode signals, and exponent offsets of the products. FIG. 5 shows exponent offsets of the sums produced by the adders. The tables show that the S-block computes the product of two single precision values in one cycle, and the D-block can compute the product of another two single precision values in the same cycle.

The states of the mode signals are shown on a per-block basis for one cycle. The p-terms for A and B are shown in columns labeled A and B, and the “sum” is the sum of the A and B p-term indices, which range from 0 to 2, since the 23 bit mantissa is split into 3, 8-bit values. The MSB and LSB exponent offsets (relative to the sum of the exponents of A and B) are shown by the blocks in the products of multiplier circuits and sums of adders columns. The grouping of products of the shown in FIG. 4 and the sums shown in FIG. 5 corresponds to the products and sums generated by the multiplier circuits and adders in the S-block of FIG. 2 and D-block of FIG. 3. The mode1 control signal is logic 1 in single precision floating point mode and logic 0 only in block floating point mode. Different arrangements of p-terms could obviate the need for the shift circuits in FIG. 2. However, concatenation of A0*B0 and A1*B1 for both single and double precision floating point modes would be needed.

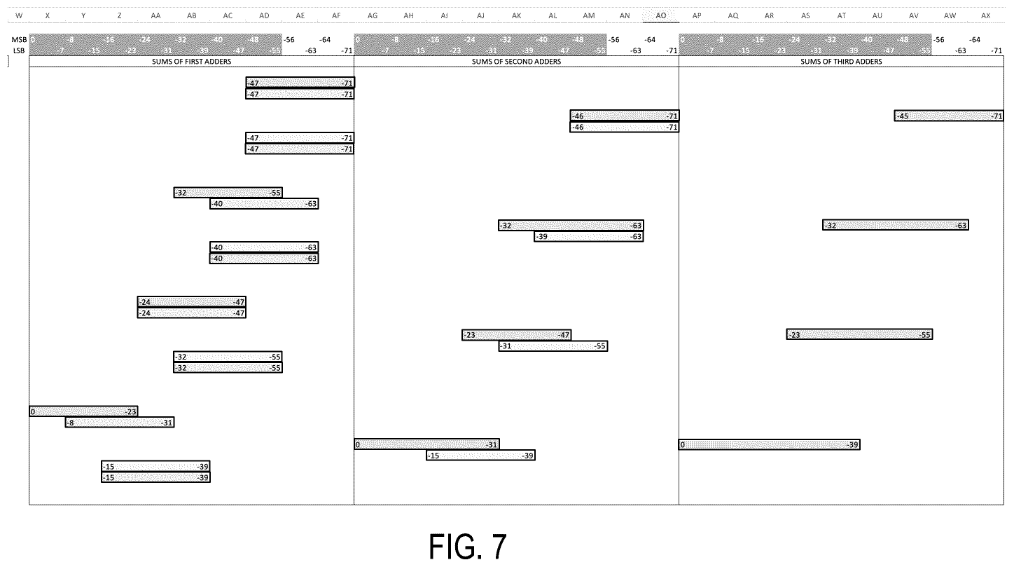

FIG. 6 shows a first part and FIG. 7 shows a second part of a table that illustrates multiplication of two double precision values by an S-block and a D-block operating in double precision floating point mode. The A and B p-term indices range from 0 to 6 (A0-A6 and B0-B6), since the 53 bit mantissa is decomposed into 7, 8-bit values.

The product of two double precision floating point values is computed in two cycles, whereas the product of a single precision floating point value is computed in one cycle. In double precision floating point mode, the lowest magnitude products can be computed in the first of the two cycles, and those products would have exponent offsets 32 less than the exponent offsets in the S-block.

Even though bits of less significance than the most significant 56 bits may not be needed, the lower order bits can be carried through, because the adder widths are not fully utilized until the second cycle. In addition, accumulation of the lower magnitude products in the first cycle allows those products to contribute to the final result.

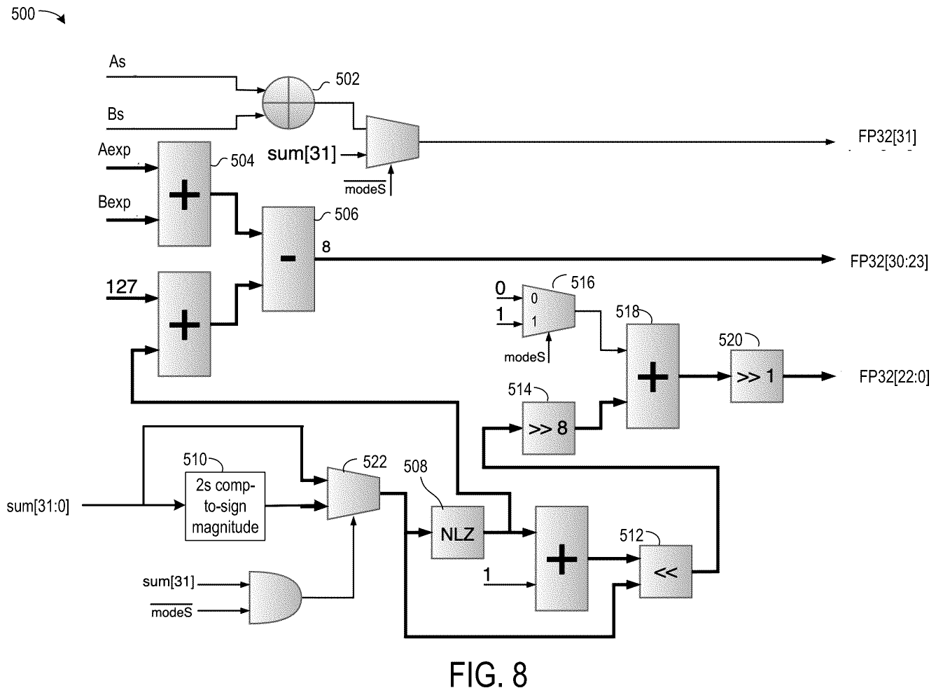

FIG. 8 shows an exemplary circuit that implements a conversion-to-floating-point circuit of an S-block. The conversion-to-floating-point circuit 500 converts the final sum (sum[31:0]) and the exponents (Aexp and Bexp) and signs (As and Bs) of A and B to a floating point representation. Conversion involves determination of the sign bit, the normalized biased exponent, and the explicit rounded significand. The sign bit is generated by XOR circuit 502 in response to sign bits As and Bs.

The pre-normalized exponent is the sum of the Aexp and Bexp by adder 504. Because both exponents Aexp and Bexp are biased, one of those biases is subtracted from the sum by subtractor 506.

Normalization depends on the value of the MSB (sum[31]) of the final sum. If the MSB of the final sum in floating point mode is one, the normalized exponent is unchanged, and that one bit will be discarded (becoming the implicit 1). The NLZ circuit 508 counts the number of leading zeros in the final sum. If the MSB of the final sum is zero, the number of leading zeros is subtracted from the exponent to complete normalization. The sum is shifted left by shift circuit 512 by the number of leading zeros plus 1 without increasing the bit width to remove any leading zeros and the initial 1 bit, which becomes the implicit one bit.

The bottom 8 bits of the 32-bit normalized sum are truncated by right shift circuit 514, leaving 24 bits for the significand.

In block floating point mode, the significand does not need to be rounded, because the maximum bit width used in the final adder is 19 bits. The significand in single precision floating point mode requires rounding, which is controlled by the modeS signal. In response to the state of modeS signal, multiplexer 516 selects either 0 or 1 for input to adder 518. After adding the round bit value, shift circuit 520 shifts the significand right by 1 bit, leaving a 23-bit significand for an FP32 value. Alternatively, the rounding can be ties to nearest even.

For operating in block floating point mode, conversion circuit 510 converts a negative twos-complement value to a positive signed magnitude value. In response to the modeS signal being logic 0 (block floating point mode) and the MSB of the sum (sum[31]) being 1, multiplexer 522 selects the signed magnitude value from the conversion circuit 510. In response to the modeS signal being logic 1 (single precision floating point mode), multiplexer 522 selects the sum output from the adder tree (sum[31:0]).

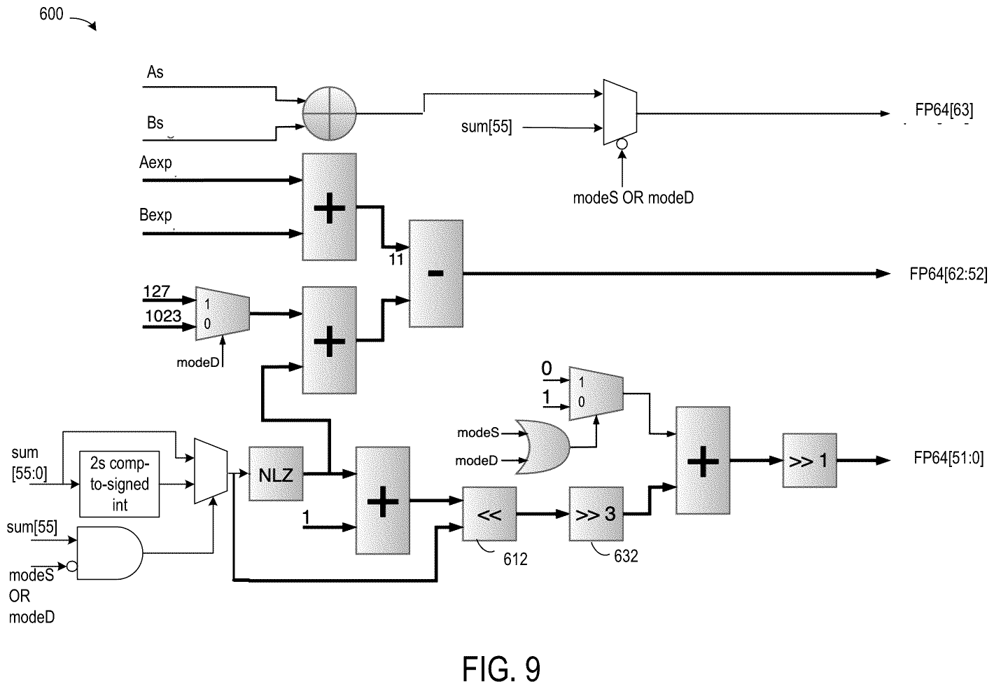

FIG. 9 shows an exemplary circuit that implements a conversion-to-floating-point circuit 600 of a D-block. The logic and circuits of the D-block conversion-to-floating-point circuit 600 are similar to the logic and circuits of the S-block conversion-to-floating-point circuit 500, with exceptions including the width of the input final sum (sum[55:0]) is 56 bits, the exponent bias of a double precision value is 1024 instead of 127, the modeD control signal is used in combination with the modeS control signal, because the D-block conversion-to-floating-point circuit 600 can operate in block floating point mode, single precision floating point mode, or double precision floating point mode. As the bit width of the input sum is wider for multiplying double precision floating point values, the widths of the adders and subtractor are commensurately wider.

Another difference between the D-block conversion-to-floating-point circuit 600 and the S-block conversion-to-floating-point circuit 500 is that following the left shift by shift circuit 512 (by the number of leading zeros plus 1) in the S-block conversion-to-floating-point circuit 500, the sum is shifted right by 8. In contrast, in the D-block conversion-to-floating-point circuit 600, following the left shift by shift circuit 612 (by the number of leading zeros plus 1) the sum is shifted right by 3 by shift circuit 632. The right-shift by 3 aligns the mantissa sections for double precision.

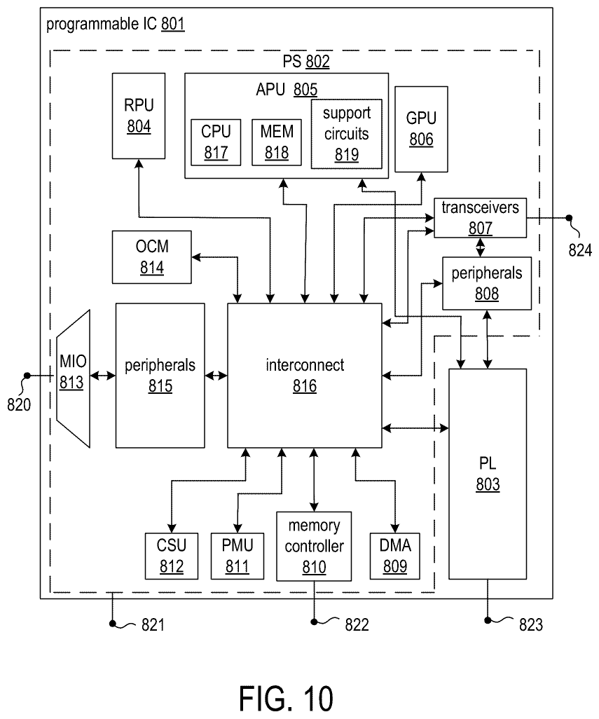

FIG. 10 is a block diagram depicting a System-on-Chip (SoC) 801 that can host the multiplication circuitry according to an example. In the example, the SoC includes the processing subsystem (PS) 802 and the programmable logic subsystem 803. The processing subsystem 802 includes various processing units, such as a real-time processing unit (RPU) 804, an application processing unit (APU) 805, a graphics processing unit (GPU) 806, a configuration and security unit (CSU) 812, and a platform management unit (PMU) 811. The PS 802 also includes various support circuits, such as on-chip memory (OCM) 814, transceivers 807, peripherals 808, interconnect 816, DMA circuit 809, memory controller 810, peripherals 815, and multiplexed (MIO) circuit 813. The processing units and the support circuits are interconnected by the interconnect 816. The PL subsystem 803 is also coupled to the interconnect 816. The transceivers 807 are coupled to external pins 824. The PL 803 is coupled to external pins 823. The memory controller 810 is coupled to external pins 822. The MIO 813 is coupled to external pins 820. The PS 802 is generally coupled to external pins 821. The APU 805 can include a CPU 817, memory 818, and support circuits 819. The APU 805 can include other circuitry, including L1 and L2 caches and the like. The RPU 804 can include additional circuitry, such as L1 caches and the like. The interconnect 816 can include cache-coherent interconnect or the like.

Referring to the PS 802, each of the processing units includes one or more central processing units (CPUs) and associated circuits, such as memories, interrupt controllers, direct memory access (DMA) controllers, memory management units (MMUs), floating point units (FPUs), and the like. The interconnect 816 includes various switches, busses, communication links, and the like configured to interconnect the processing units, as well as interconnect the other components in the PS 802 to the processing units.

The OCM 814 includes one or more RAM modules, which can be distributed throughout the PS 802. For example, the OCM 814 can include battery backed RAM (BBRAM), tightly coupled memory (TCM), and the like. The memory controller 810 can include a DRAM interface for accessing external DRAM. The peripherals 808, 815 can include one or more components that provide an interface to the PS 802. For example, the peripherals can include a graphics processing unit (GPU), a display interface (e.g., DisplayPort, high-definition multimedia interface (HDMI) port, etc.), universal serial bus (USB) ports, Ethernet ports, universal asynchronous transceiver (UART) ports, serial peripheral interface (SPI) ports, general purpose (GPIO) ports, serial advanced technology attachment (SATA) ports, PCIe ports, and the like. The peripherals 815 can be coupled to the MIO 813. The peripherals 808 can be coupled to the transceivers 807. The transceivers 807 can include serializer/deserializer (SERDES) circuits, MGTs, and the like.

Various logic may be implemented as circuitry to carry out one or more of the operations and activities described herein and/or shown in the figures. In these contexts, a circuit or circuitry may be referred to as “logic,” “module,” “engine,” or “block.” It should be understood that logic, modules, engines anD-blocks are all circuits that carry out one or more of the operations/activities. In certain implementations, a programmable circuit is one or more computer circuits programmed to execute a set (or sets) of instructions stored in a ROM or RAM and/or operate according to configuration data stored in a configuration memory.

Though aspects and features may in some cases be described in individual figures, it will be appreciated that features from one figure can be combined with features of another figure even though the combination is not explicitly shown or explicitly described as a combination.

The circuits and methods are thought to be applicable to a variety of systems for block floating point and floating point multiplication. Other aspects and features will be apparent to those skilled in the art from consideration of the specification. The circuits and methods may be implemented as one or more processors configured to execute software, as an application specific integrated circuit (ASIC), or as a logic on a programmable logic device. It is intended that the specification and drawings be considered as examples only, with a true scope of the invention being indicated by the following claims.

What is claimed is:

1. A circuit arrangement comprising:
a mode control circuit configured to operate the circuit arrangement in either a first mode to multiply a first floating point operand by a second floating point operand or a second mode to compute a dot product of first and second vectors of block floating point values;
a first block of multiplier circuits configured to generate products from first pairs of p-terms, wherein each p-term is a portion of a significand of either the first or second floating point operand when operating in the first mode, and each p-term is a significand of one of the block floating point values when operating in the second mode;
a first adder tree coupled to the first block of multiplier circuits and configured to sum the products into a first final sum; and
a first floating point conversion circuit coupled to the first adder tree and configured to generate a floating point value from output of the first adder tree and the first and second floating point operands in response to operating in the first mode, and generate a block floating point value from output of the first adder tree in response to operating in the second mode.

2. The circuit arrangement of claim 1, wherein the first adder tree is configured to align products for summing according to exponent offsets of the p-terms in response to operating in the first mode, and the first adder tree is configured to bypass alignment of the products in response to operating in the second mode.

3. The circuit arrangement of claim 2, wherein the first adder tree includes shift circuits configured to align the products in response to the mode control circuit.

4. The circuit arrangement of claim 1, wherein the first floating point conversion circuit is configured to:
round the first final sum for a floating point significand in response to operating in the first mode,
generate a floating point sign bit from a sign bit of the first final sum in response to operating in the second mode, or from sign bits of the first and second floating point operands in response to operating in the first mode; and
generate a floating point exponent from exponents of the first and second floating point operands in response to operating in the first mode, or from exponents of values of the first and second vectors in response to operating in the second mode.

5. The circuit arrangement of claim 1, further comprising a selection circuit coupled to the mode control circuit, the multiplier circuits, and a data bus, wherein the selection circuit is configured to:
select from the data bus,
signals of the portions of the significands of the first and second floating point operands, signals of sign bits of the first and second floating point operands, and signals of exponents of the first and second floating point operands in response to a mode control signal from the mode control circuit indicating the first mode, and
signals of the significands of the block floating point values, and signals of exponents of values of the first and second vectors in response to a mode control signal from the mode control circuit indicating the second mode; and
provide the selected signals as the p-terms to the multiplier circuits and to the first floating point conversion circuit.

6. The circuit arrangement of claim 1, wherein the mode control circuit is configured to operate the circuit arrangement in either a first precision mode or a second precision mode, and the circuit arrangement further comprising:
a second block of multiplier circuits configured to generate products from second pairs of p-terms, wherein each p-term of the second pairs is a portion of the significand of either the first or second floating point operand while operating in the second precision mode and a portion of a significand of either a third or fourth floating point operand while operating in the first precision mode;
a second adder tree coupled to the second block of multiplier circuits, the first adder tree, and the mode control circuit, and operable in either the first precision mode or the second precision mode in response to control signals from the mode control circuit, wherein the second adder tree configured to:
align the products from the second block of multiplier circuits for summing according to exponent offsets of the p-terms of the second pairs of p-terms in the third and fourth floating point operands while operating in the first precision mode, or according to exponent offsets of the p-terms of the second pairs of p-terms in the first and second floating point operands while operating in the second precision mode,
sum the products from the second block of multiplier circuits into a second final sum, and
sum the first final sum and the second final sum into a second precision sum in response to operating in the second precision mode;
a second floating point conversion circuit coupled to the second adder tree and configured to:
round the second precision sum for a floating point significand,
generate a floating point sign bit from sign bits of the first and second floating point operands in response to operating in the second precision mode; and
generate a floating point exponent from exponents of the first and second floating point operands in response to operating in the second precision mode, or from exponents of the third and fourth floating point operands in response to operating in the first precision mode.

7. The circuit arrangement of claim 6, wherein:
the p-terms of the second pairs of p-terms are significands of block floating point values of third and fourth vectors when operating in the second mode;
the second adder tree is configured to bypass alignment of products in response to operating in the second mode; and
the second floating point conversion circuit is configured to:
generate a floating point sign bit from a sign bit of the second final sum in response to operating in the second mode; and
generate a floating point exponent from exponents of values of the third and fourth vectors in response to operating in the second mode.

8. The circuit arrangement of claim 1, further comprising:
a plurality of twos-complement conversion circuits coupled between the first block of multiplier circuits and the first adder tree and configured to convert the products to twos-complement representation for summing when operating in the second mode; and
wherein the first floating point conversion circuit is configured to convert the first final sum from twos-complement representation to sign-magnitude representation or a floating point significand in response to operating in the second mode.

9. The circuit arrangement of claim 1, wherein the mode control circuit is configured to gate clock signals for enabling and disabling selected ones of the multiplier circuits of the first block according to a level of precision of operands when operating in the first mode.

10. A circuit arrangement comprising:
a mode control circuit configured to operate the circuit arrangement in either a first mode to multiply pairs of first and second floating point operands or a second mode to compute dot products of pairs of first and second vectors of block floating point values;
a plurality of blocks of multiplier circuits, each block of multiplier circuits configured to generate products from first pairs of p-terms, wherein each p-term is a portion a significand of either the first or second floating point operand when operating in the first mode, and each p-term is a significand of one of the block floating point values when operating in the second mode;
a plurality of adder trees coupled to the blocks of multiplier circuits, respectively, wherein each adder tree configured to sum the products of the respectively coupled block of multiplier circuits into a final sum; and
a plurality of floating point conversion circuits coupled to the adder trees, respectively, wherein each floating point conversion circuits is configured to generate a floating point value from output of the respectively coupled adder tree and the first and second floating point operands in response to operating in the first mode, and generate a block floating point value from output of the respectively coupled adder tree in response to operating in the second mode.

11. The circuit arrangement of claim 10, wherein each adder tree is configured to align products for summing according to exponent offsets of the p-terms in response to operating in the first mode, and bypass alignment of the products in response to operating in the second mode.

12. The circuit arrangement of claim 10, further comprising:
a respective plurality of two-complement conversion circuits coupled between the each block of multiplier circuits and the respectively coupled adder tree and configured to convert the products to twos-complement representation for summing when operating in the second mode; and
wherein each floating point conversion circuit is configured to convert the final sum from twos-complement representation to sign-magnitude representation or a floating point significand in response to operating in the second mode.

13. The circuit arrangement of claim 10, wherein the mode control circuit is configured to gate clock signals for enabling and disabling selected ones of the multiplier circuits of the first block according to a level of precision of operands when operating in the first mode.

14. A circuit arrangement comprising:
a mode control circuit configured to operate the circuit arrangement in a first mode or a second mode to multiply pairs of first and second floating point operands, or a third mode to compute dot products of pairs of first and second vectors of block floating point values;
a plurality of first-type blocks coupled to the mode control circuit;
a plurality of second-type blocks coupled to the mode control circuit, wherein each second-type block is paired with and coupled to one of the first-type blocks;
wherein each first-type block and each second-type block includes a block of multiplier circuits, respectively, the multiplier circuits of each block are configured to generate products from pairs of p-terms, the p-terms input to the multiplier circuits of each first-type block and second type block are significands of the block floating point values of one of the pairs of first and second vectors when operating in the third mode, the p-terms input to the multiplier circuits of each paired first-type block and second-type block are portions of the significands of two pairs of first and second floating point operands while operating in the first mode, and the p-terms input to the multiplier circuits of each paired first-type and second-type blocks are portions of the significands of one pair of first and second floating point operands while operating in the second mode;
wherein each first-type block and each second-type block includes a respective adder tree coupled to the block of multiplier circuits, and each adder tree is configured to sum the products of the coupled block of multiplier circuits into a final sum;
wherein each second-type block is configured to sum the final sum of the paired first-type block with the final sum of the second-type block into a second precision sum in response to operating in the second mode;
wherein each first-type block and each second-type block includes a floating point conversion circuit coupled to the respective adder tree, and the floating point conversion circuit of each first and second type block is configured to generate a floating point value at a first level of precision from output of the respective adder tree and the first and second floating point operands, in response to operating in the first mode, and generate a block floating point value from output of the respective adder tree in response to operating in the third mode; and
wherein the floating point conversion circuit of the second-type block is configured to generate a floating point value at a second level of precision from the second precision sum and the first and second floating point operands, in response to operating in the second mode.

15. The circuit arrangement of claim 14, wherein each adder tree is configured to align products for summing according to exponent offsets of the p-terms in the first and second floating point operands in response to operating in the first and second modes, and bypass alignment of the products in response to operating in the third mode.

16. The circuit arrangement of claim 15, wherein each respective adder tree includes shift circuits configured to align the products in response to the mode control circuit.

17. The circuit arrangement of claim 14, wherein each floating point conversion circuit of the first-type blocks is configured to:
round the final sum for a floating point significand in response to operating in the first mode for second mode,
generate a floating point sign bit from a sign bit of the final sum in response to operating in the third mode, or from sign bits of the first and second floating point operands in response to operating in the first mode or second mode; and
generate a floating point exponent from exponents of the first and second floating point operands in response to operating in the first mode or the second mode, or from exponents of values of the first and second vectors in response to operating in the third mode.

18. The circuit arrangement of claim 14, further comprising a selection circuit coupled to the mode control circuit, the first-type blocks, the second type blocks, and a data bus, wherein the selection circuit is configured to:
select from the data bus,
signals of the portions of the significands of the pairs of first and second floating point operands, signals of sign bits of the pairs of first and second floating point operands, and signals of exponents of the pairs of first and second floating point operands in response to a mode control signal from the mode control circuit indicating the first mode or the second mode, and
signals of the significands of the block floating point values, and signals of exponents of values of the first and second vectors in response to a mode control signal from the mode control circuit indicating the third mode; and
provide the selected signals as the p-terms to the multiplier circuits of the first-type blocks, the second-type blocks, and to the respective floating point conversion circuits.

19. The circuit arrangement of claim 14, wherein:
each first-type block and each second-type block includes a respective plurality of twos-complement conversion circuits coupled between the multiplier circuits and the respective adder tree and configured to convert the products to twos-complement representation for summing when operating in the third mode; and
each floating point conversion circuit is configured to convert the final sum from twos-complement representation to sign-magnitude representation or a floating point significand in response to operating in the third mode.

20. The circuit arrangement of claim 14, wherein the mode control circuit is configured to gate clock signals for enabling and disabling selected ones of the multiplier circuits of the first-type blocks and second-type blocks according to a level of precision of operands when operating in the first mode or the second mode.
